(19) United States
(12) Patent Application Publication
(10) Pub. No.: US 2025/0173448 A1
(43) Pub. Date: May 29, 2025

(54) SYSTEMS AND METHODS TO TOKENIZE AND CATEGORIZE DATA TRANSACTIONS

(71) Applicant: Bank of America Corporation, Charlotte, NC (US)

(72) Inventors: Frency George Thomas, Chennai (IN); Shailendra Singh, Maharashtra (IN); Deepiga Venkatachalam, Maharashtra (IN); Shoumi Mukherjee, Maharashtra (IN); Suhasini Mullapudi, Chennai (IN)

(21) Appl. No.: 18/523,123

(22) Filed: Nov. 29, 2023

(51) Int. Cl. G06F 21/62; G06F 21/60; H04L 67/1097

(52) U.S. Cl. CPC G06F 21/6218; G06F 21/602; H04L 67/1097

(57) ABSTRACT

An interactive distributive platform apparatus configured to be a single source of truth. The platform may include entity identifier data stored in a database. The data may be placed in a grid through an AI algorithm. The AI algorithm may place the data in the grid using one or more rules. The data may be extracted into datasets. The datasets may be placed in corresponding selected nodes. Placement of the datasets may occur using smart contracts. The nodes may be part of a holochain. The datasets and rules may be validated in an interactive distributive platform. The interactive distributive platform may be the single source of truth. The interactive distributive platform may direct any request that enters the system to the correct node.

### FIELD OF TECHNOLOGY

Aspects of the disclosure relate to tokenizing and categorizing data.

### BACKGROUND OF THE DISCLOSURE

Currently, a system may have many sources of truth. For the purposes of this application the term a single source of truth may be understood to refer to a mandatory storage with a system of record that is devoted to providing a unique origin for one or more data points. Multiple sources of truth may raise core challenges when the system needs to access data and other applicable activities.

A core challenge that may arise from the multiple sources of truth may include fragmented data. Fragmentation of data typically adds one or more layers of complexity when trying to access data. The fragmentation of the data may also create a need for a more complex architecture to resolve the fragmentation. There may be additional layers of features required to access the data. The many layers of features in the complex architecture may cause further complications in the architecture.

Moreover, fragmentation of data may drive inconsistency with respect to data sourcing, reconcilement and/or other areas. Inconsistency generates a need for more reconcilements than is optimal. Inconsistency also adds complexity when a system administration tries to implement new business initiatives.

Furthermore, fragmentation of data initiates a need for manual workarounds. Manual workarounds create an inconsistent user and/or client experience across flows. Inconsistency in user and/or client experience may discourage users and/or clients from using the system.

Therefore, it is desirable to create a system that tokenizes relevant data and categorizes the data in an efficient and consistent way creating a one source of truth, i.e., a single source of truth, by culling the data found among many sources of truth.

### SUMMARY OF THE DISCLOSURE

Apparatus, methods, and systems for tokenizing and categorizing data transactions are provided. A system may include a database. In some embodiments, a database stores data. There may be one or more databases that are used for data storage in the system. There may be various communication blocks used to provide access to the data stored among the database and/or databases.

In addition to granting access to the data, the communication blocks may provide storage for the data. In such embodiments, the communication blocks may generate many sources of truth. Each of the many sources of truth may create a unique value for the data. This may create multiple values for identical data.

Therefore, it may be desirable to create a single source of truth. The single source of truth may be found among an interactive distributive platform. The interactive distributive platform may be created through culling data from the stored communication blocks and the many sources of truth. The many sources of truth may be found among various communication and/or storage blocks. The data stored among the communication blocks may be entity identifier data and/or other data. For the purposes of this application, the term entity identifier data may be understood to refer to a unified identification code expressed as a particular data value.

To establish a single source of truth, an AI algorithm may be generated. The AI algorithm may be preprogrammed to cull the entity identifier data and/or other data stored among the communication blocks periodically or continuously. The AI algorithm may be further preprogrammed to place the data that has been culled from among the various communication blocks in a grid or a matrix.

The AI algorithm may create the grid designed for placement of the culled data. The grid may be a dynamic grid. The dynamic grid may be constructed for placement, division and, later in-time, extraction of the culled data. Placement of the culled data may occur in conjunction with the division of the culled data.

Division of the culled data may take place through an identification process. The identification process may include one or more rules. The one or more rules may be identification rules. The identification rules may include entity rules, token rules and/or other relevant rules. The identification rules may be rules that create one unique value for the data. The rules may create one unique value for the data by culling all the values that correspond to the data. The identification rules may create the unique value based on the most common value found among the communication blocks. The data may be placed in the dynamic grid for division together with the unique values. The culled data, following division, may now be referred to as divided data.

The AI algorithm may extract the divided data from the dynamic grid. Upon extraction of the divided data from the dynamic grid, the divided data may be referred to as datasets. There may be one or more datasets extracted from the dynamic grid. The datasets may have been the culled data divided in accordance with the entity rules, token rules and/or other rules.

Extraction of the plurality of datasets may be followed by storage of the datasets. Storage of each of the one or more datasets may be in selected nodes. The selected nodes may be selected from among a pool of decentralized nodes using smart contracts. For the purposes of this application smart contracts may be a self-executing computer program that automatically executes the terms of the contracts. The nodes may be selected as they may correspond to one or more of the datasets. The smart contracts may determine nodes that correspond to the datasets. The datasets may be assigned and placed among corresponding selected nodes. Smart contracts may assign one or more of the datasets to one or more of the corresponding selected nodes.

Upon assigning the datasets to selected nodes, the datasets, the identification rules and the values may receive validation. Validation of the datasets, the identification rules and values may occur in an interactive distributive platform. For purposes of this application, an interactive distributive platform should be understood to refer to a location that provides on-demand unified data information.

Upon validation of the datasets, the identification rules and the unique values in the interactive distributive platform, a single source of truth may be created and utilized. The single source of truth may be found among the interactive distributive platform. A system may request on-demand access to data. Access to data may be granted with the use of the single source of truth. Smart contracts may direct the on-demand requests to the correct node by determining the correct node, i.e., the node that corresponds to the data, in the interactive distributive platform.

Through the creation of systems and methods for tokenizing and categorizing data transactions, data may be stored and accessed with a single source of truth. The single source of truth may ensure an efficient workflow. Reduced reconciliations, resulting from a single source of truth, may add an additional benefit to systems. Systems may complement less complex architecture. Less complex architecture promotes smoothness while sourcing data. For these reasons as well as others, creating a single source of truth may increase efficiency in information systems.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows an illustrative flow diagram in accordance with the principles of the disclosure;

FIG. 4 shows another illustrative flow diagram in accordance with the principles of the disclosure;

FIG. 5 shows still another illustrative flow diagram in accordance with the principles of the disclosure;

FIG. 6 shows yet another illustrative flow diagram in accordance with the principles of the disclosure.

FIG. 7 shows yet another illustrative flow diagram in accordance with the principles of the disclosure.

### DETAILED DESCRIPTION OF THE DISCLOSURE

Apparatus, systems, and methods for categorizing and tokenizing data transactions are provided. Methods may include creating an interactive distributive platform that provides a single source of truth. The interactive distributive platform may provide a way of responding to on-demand requests in real-time.

The methods for tokenizing and categorizing data transactions may include a system. The system may create an interactive distributive platform. The interactive distributive platform may be used to categorize and tokenize data.

The interactive distributive platform may retrieve the data. The data may have been retrieved from a system. The data may be entity identifier data and/or other data.

The system that the data may have been retrieved from, may include numerous communication blocks. The communication blocks may store the data. The data may have many sources of truth because of being stored in several different communication blocks. The communication blocks may have unique values for identical data. Unique values for identical data may result in many sources of truth. The data stored among the communication blocks may be the data used by the interactive distributive platform.

The interactive distributive platform may include a microprocessor. The microprocessor may be designed to create a generative AI algorithm. The AI algorithm may be designed to cull and place the data in a grid or matrix.

The AI algorithm may be constructed to create the grid or matrix qualified for placement of the data. The grid may be a dynamic grid, i.e., the grid may be a grid that can transform single data points into datasets. The datasets may be created from the data extracted from the dynamic grid.

The AI algorithm may be designed to cull the data using rules. The identification rules may be token rules, entity rules and/or other relevant rules. These rules may determine one unique value for the data. The AI algorithm may determine the unique value based on a most common value found among the many communication blocks. The identification rules may be constructed and maintained by the AI algorithm. The dynamic grid may be generated to cull and divide the data in the dynamic grid using the identification rules. The identification rules may assist in dividing the culled data in an orderly and traceable manner.

The dynamic grid may be further designed to generate an extraction of the divided data. One or more datasets may emerge from the extraction. The datasets may be the data after extracted from the dynamic grid.

The datasets, formed from the extraction of the data, may be clustered out. Clustering out the datasets may occur with the use of smart contracts. The smart contracts may cluster out the datasets into one or more decentralized nodes. The smart contracts may cluster out the datasets by identifying a corresponding decentralized node from among a pool of decentralized nodes. Each of the decentralized nodes may correspond to one or more datasets. For purposes of this application, the nodes that may have been selected by the smart contracts may be referred to hereinafter as selected nodes. The selected nodes may correspond to one or more specific datasets. The smart contracts may cluster out the datasets to a selected corresponding node.

The decentralized pool of nodes may also be referred to as a holochain. The holochain for the purposes of this application may be a group of nodes that may use a distributed hash table to keep a record of the essential type and validity of data that each individual node contributes. The holochain may bring a connection to all the nodes and may therefore assist in creating a single source of truth. The interactive distributive platform may be a base for the holochain.

After the smart contracts place the datasets among the selected nodes, the datasets and/or rules may receive validation. Validation of the datasets and/or rules may occur in an interactive distributive platform. The interactive distributive platform may generate a unique value for each of the data and datasets that store the data. The unique value may be generated by the interactive distributive platform using previously stored values. A previously stored value for the purposes of this application may be an alphanumeric value that corresponds to one or more data and/or datapoints. There may be different values created by blocks, nodes and/or other hardware or software suitable for storage of the data.

The identification rules along with the AI algorithm may determine the most common value for the data. The AI algorithm may then create a unique value for the data that is based on the most common value found among the communication nodes and multiple sources of truth. It should be noted that the value for the data may be an alphanumeric value and/or other values. The interactive distributive platform may validate the datasets. The identification rules and the unique values through validation create a single source of truth.

Upon validation and creation of the single source of truth, the single source of truth may be utilized in the system. The single source of truth may be utilized to respond to on-demand requests and/or other requests that may enter the system. The system may need to direct the on-demand requests and/or other requests to the correct nodes.

Smart contracts, through use of the interactive distributive platform and single source of truth, may determine select nodes. Selected nodes may be determined as they may provide a correct response to the on-demand request and/or other requests. The data may be accessed, retrieved, and may provide a response. The smart contracts may direct the response to the on-demand request and/or other requests.

Smart contracts may additionally determine which of the datasets and corresponding nodes may necessitate an external response to an on-demand request. The external response may be received by external systems. It should be noted that for the purposes of this application the external system may be a front-end of a computer and or other external systems.

The datasets and corresponding nodes that may necessitate an external response may entail alerting the system. Smart contracts may be utilized to alert the system about the datasets and corresponding nodes that necessitate external responses. As each of the datasets and corresponding nodes alert the system, the system may create external access for each of the datasets and corresponding nodes.

The smart contracts may further retrieve data from among the selected nodes. The data retrieved from among the selected nodes may be data necessary to respond to the on-demand requests in real-time. The smart contracts may determine which data is needed to respond to the one or more on-demand requests by validating the on-demand requests in the interactive distributive platform.

Through the creation of systems and methods to tokenize and categorize data transactions, data may be stored and accessed using a single source of truth. The single source of truth may ensure an efficient workflow. Reduced reconciliations, resulting from a single source of truth, may be an additional benefit to systems. Systems may handle less complex architecture. Less complex architecture may obtain less errors while sourcing data. For these reasons and/or additional reasons creating a single source of truth may increase efficiency in systems.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

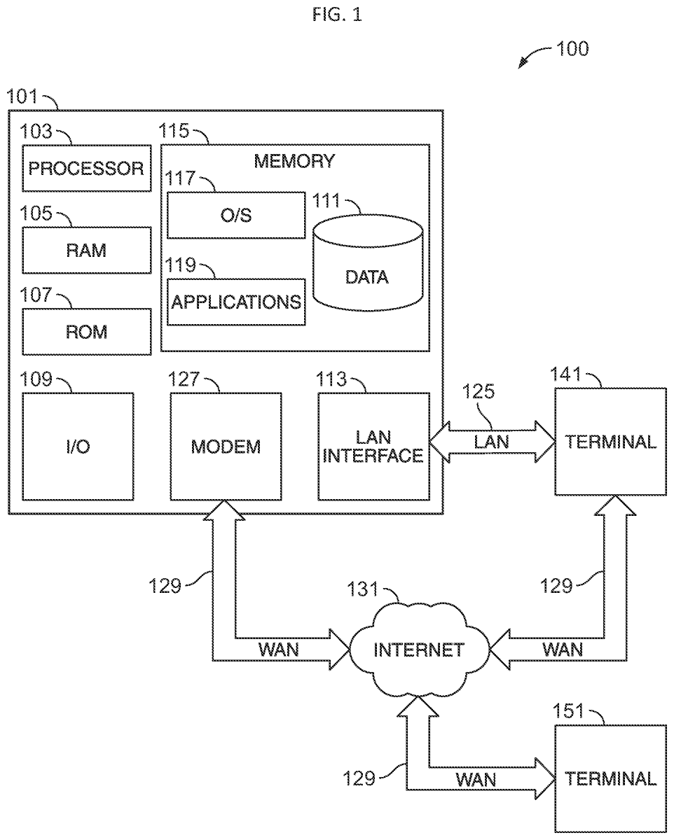

FIG. 1 shows an illustrative block diagram of apparatus 100 that includes a computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more processors/microprocessors 103 for controlling the operation of the device and its associated components, and may include RAM 105, ROM 107, input/output module 109, and a memory 115. The microprocessors 103 may also execute all software running on the computer 101—e.g., the operating system 117 and applications 119 such as an artificial intelligence implemented termination program and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as an artificial intelligence implemented termination program and security protocols) along with any other data 111 (e.g., historical data, configuration files) needed for the operation of the apparatus 100. Memory 115 may also store applications and data. Data that may be stored by memory 115 may be entity identifier data and/or other data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, Wi-Fi, cellular networks, or other suitable frequencies.

Any memory may be comprised of any suitable permanent storage technology—e.g., a hard drive or other non-transitory memory. The memory may store software including an operating system and any application(s) (such as an artificial intelligence implemented termination program and security protocols) along with any data needed for the operation of the apparatus and to allow bot monitoring and IoT device notification. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. In such an embodiment apparatus 100 may be an interactive distributive platform. A computer 101 may be a mobile computing device such as a smartphone or tablet and/or one or more communication blocks.

Apparatus 100 may be connected to other systems, computers, servers, devices, and/or the Internet 131 via a local area network (LAN) interface 113. Interface 113 may be a holochain and/or other interfaces.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all the application data, logic, and instructions are located on the internet and are not located on a user's local device. Cloud-based applications may be accessed via any type of internet connection (e.g., cellular or Wi-Fi).

Terminals 141 and 151 may be personal computers, smart mobile devices, smartphones, IoT devices, or servers that include many or all the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, Wi-Fi, cellular networks or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for an artificial intelligence implemented termination program and security protocols, as well as other programs. In an embodiment, one or more programs, or aspects of a program, may use one or more artificial intelligence/machine learning (“AI/ML”) algorithm(s). The various tasks may be related to terminating or preventing a malicious AI from completing its malicious activities.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, IoT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

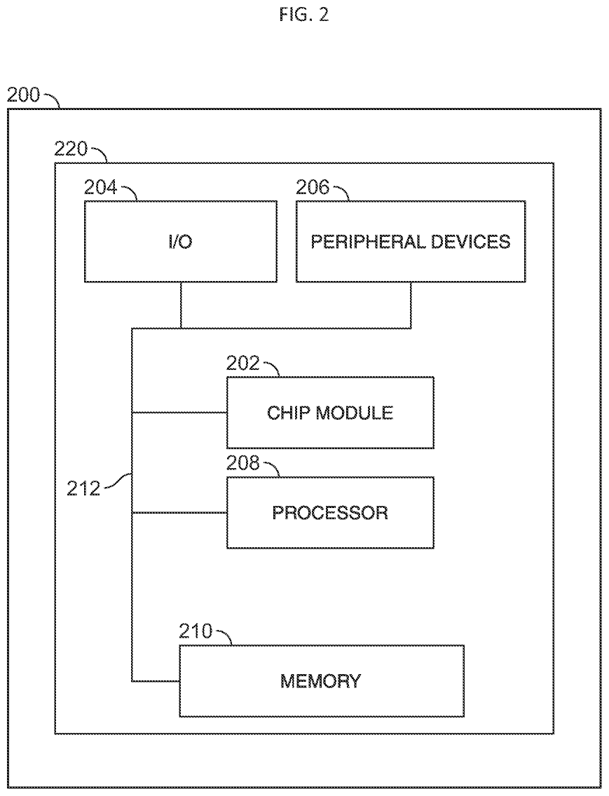

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1-7. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, a display (LCD, LED, OLED, etc.), a touchscreen or any other suitable media or devices, peripheral devices 206, which may include other computers, logical processing device 208, which may compute data information and structural parameters of various applications, and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

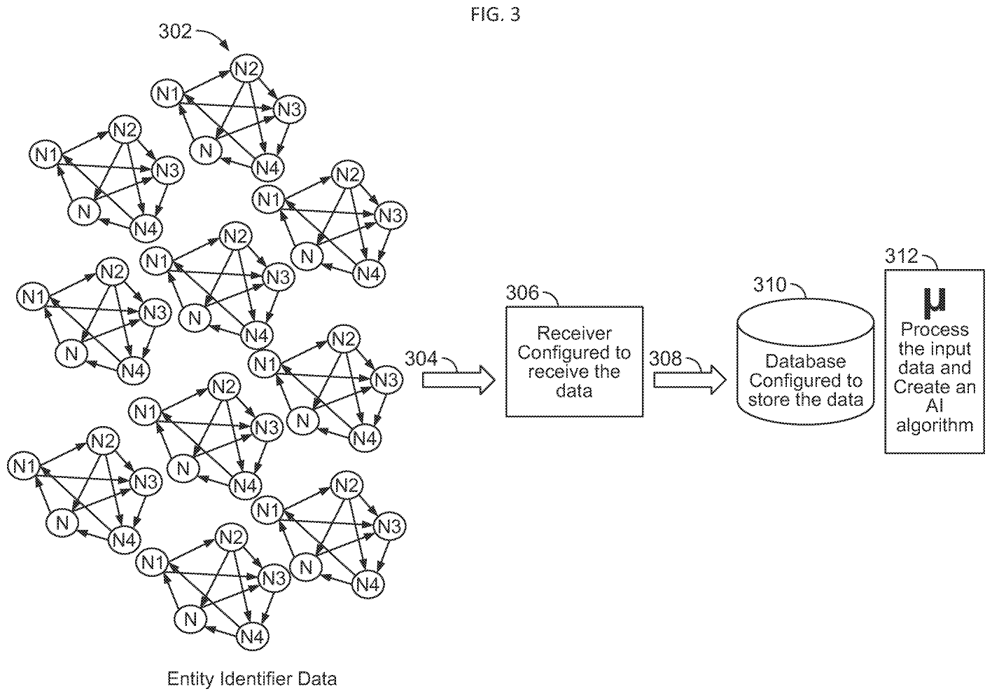

FIG. 3 shows an illustrative flow diagram. The illustrative flow diagram may show components in a system with an interactive distributive platform. The flow diagram may show data entering a system and being transmitted for storage. It should be noted that the system may create values for the data, as the data enters the system. The values may be stored in one or more communication blocks. The system may be additionally adept to respond to on-demand requests. The on-demand requests may or may not be essential for the operation of the system.

Data 302 may be the data that enters the system. Input of data 302 may be represented with arrow 304. Data 302 may be entity identifier data and/or other relevant data. Data 302 may be received by receiver 306. Receiver 306 may transmit received data 302 into database 310 (as shown with arrow 308).

Database 310 may distribute and store data 302 among one or more communication blocks that may be found throughout the system. Each of the communication blocks may create and store one or more unique values for data 302. The unique values for data 302 may be processed using a microprocessor 312 in database 310.

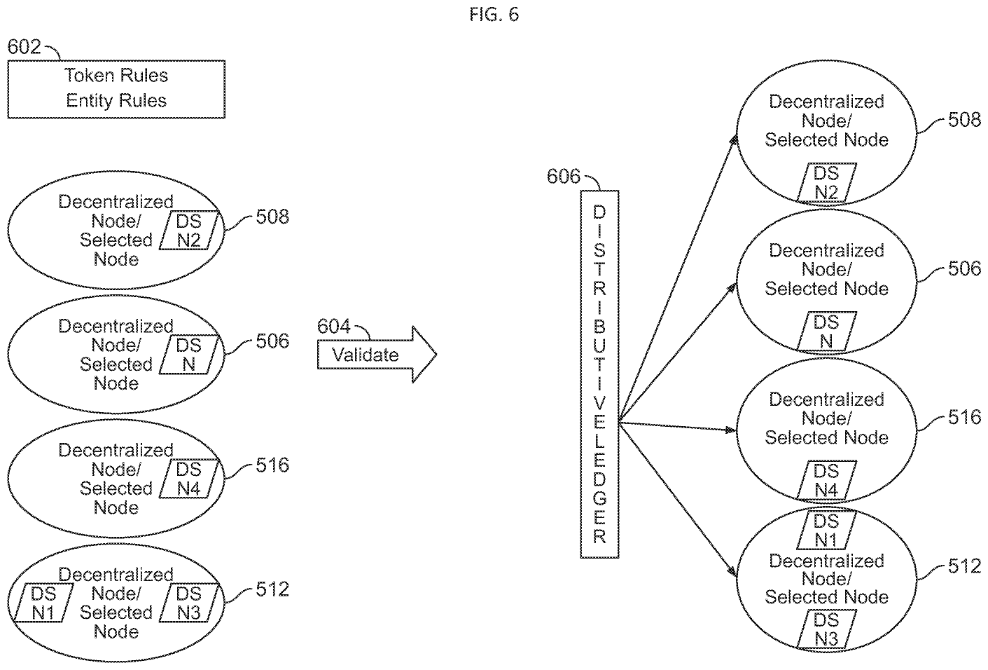

Microprocessor 312 may also be constructed to create a generative AI algorithm. The AI algorithm may be used to create a single source of truth for data 302 (as shown in detail in FIG. 6 and as described in the portion of the specification corresponding thereto.)

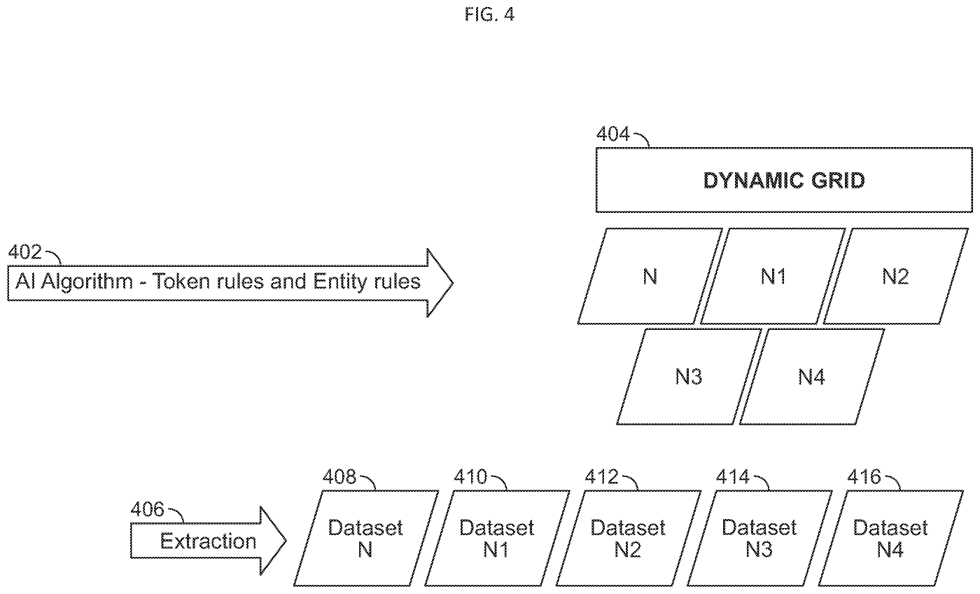

FIG. 4 shows another illustrative flow diagram. The illustrative flow diagram shows the tokenizing and categorizing of data 302. Data 302 may be stored in database 310. Database 310 may store data 302 among the various communication blocks. The entity identifier data and/or other relevant data that may have been collected and stored among the various communication blocks, may have multiple sources of truth. Each of the multiple sources of truth may have a unique value for the entity identifier data and/or other relevant data. The unique value may be one value for the data. This may result in multiple values for the same data.

It should be noted that the generative AI algorithm created by microprocessor 312, may be referenced and used in FIG. 4. The AI algorithm may produce entity rules, token rules and/or other rules. The entity rules, token rules and/or other rules may be referred to as the identification rules. The identification rules may be used to divide the collected data, as shown at step 402. Division of the data may follow the identification rules. There may be additional rules created by the AI algorithm for categorization and division of the collected data.

The collected data may be divided and categorized in a dynamic grid 404 with use of the AI algorithm and the identification rules. Dynamic grid 404 may be created by the AI algorithm as well.

The AI algorithm may further extract the divided data from dynamic grid 404, as shown with arrow 406. Dynamic grid 404 may extract the divided data into datasets 408, 410, 412, 414 and 416. Datasets 408, 410, 412, 414 and 416 may be the divided data divided in the dynamic grid 404 according to the identification rules. The datasets may be the data extracted from dynamic grid 404.

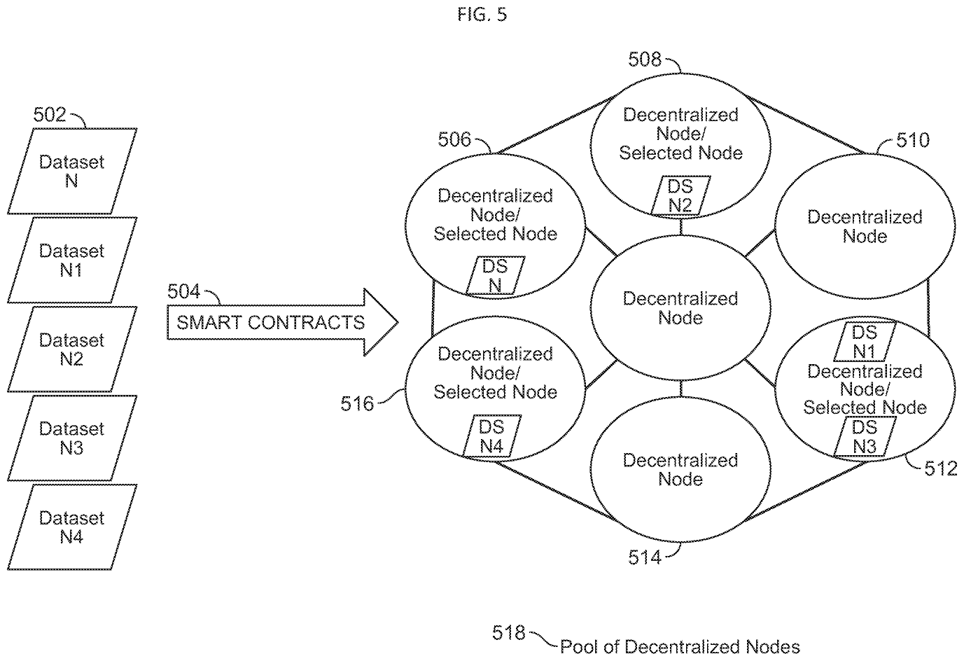

FIG. 5 shows yet another illustrative flow diagram. Datasets 502 in FIG. 5 may correspond to datasets 408, 410, 412, 414 and 416. Smart contracts 504 may cluster out datasets 502 into a pool of decentralized nodes 518. It should be noted that smart contracts 504 may assign datasets 502 to the decentralized nodes. Pool of decentralized nodes 518 may consist of decentralized nodes 506, 508, 510, 512, 514 and 516. From among pool of nodes 518, smart contracts 504 may select specific nodes that may store datasets 502. The nodes selected may be referred to as selected nodes. Nodes may be selected based on correspondence to datasets 502. The selected nodes may be nodes 506, 508, 512 and 516. Smart contracts 504 may assign to specific datasets from datasets 502 to selected nodes 506, 508, 512 and 516. Datasets 502 may be stored among the selected nodes 506, 508, 512 and 516. Smart contracts 504 may prioritize specific datasets from datasets 502 necessary to be prioritized.

FIG. 6 shows yet another illustrative flow diagram. The illustrative flow diagram shows selected decentralized nodes 506, 508, 512 and 516. Selected decentralized nodes 506, 508, 512 and 516 along with their corresponding datasets may validate in an interactive distributive platform 606 along with rules 602 (as shown in step 604). Rules 602 may be the identification rules.

Validation of decentralized nodes 506, 508, 512 and 516 along with rules 602, may make interactive distributive platform 606 a single source of truth. Interactive distributive platform 606 may be the single source of truth for the system. Interactive distributive platform 606 may validate the datasets and identification rules and create one unique value for each of the data stored in the system.

Decentralized nodes 506, 508, 512 and 516 may be accessed through interactive distributive platform 606. Interactive distributive platform 606 may direct on-demand requests that have entered the system to the correct node with use of smart contracts. Interactive distributive platform 606 may increase the efficiency of the system and create consistent data recording.

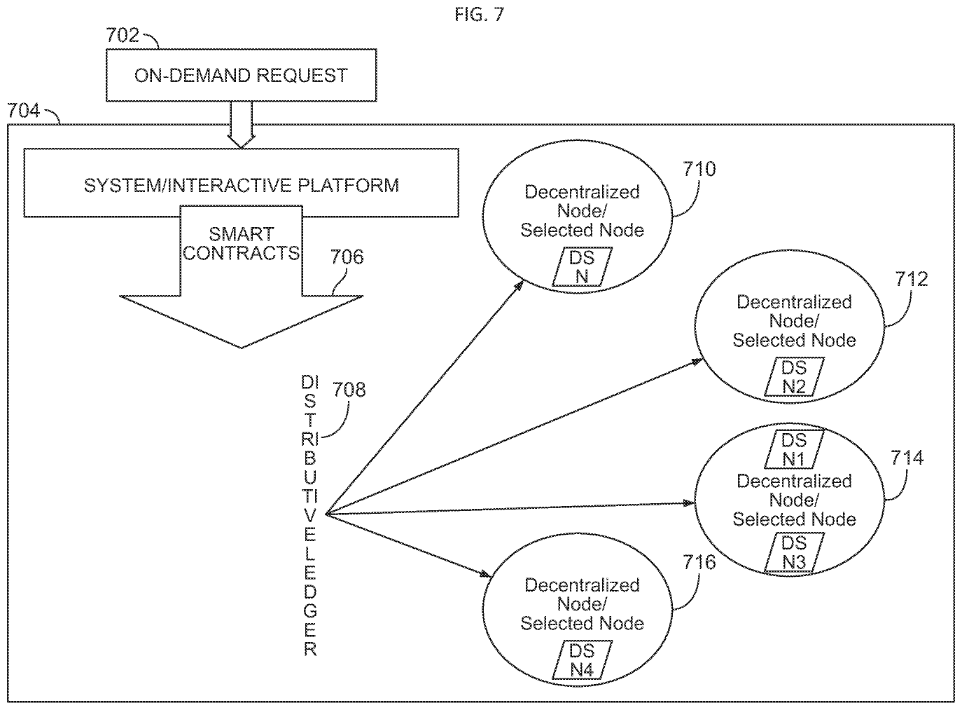

FIG. 7 shows another illustrative flow diagram. The illustrative flow diagram shows on-demand request 702 entering system 704. There may be one or more on-demand requests that enter a system, shown at on-demand request 702. System 704 is the interactive distributive platform that may have been created to provide a single source of truth. The single source of truth is shown together with interactive distributive platform 708. It should be noted that interactive distributive platform 708 corresponds directly to interactive distributive platform 606.

Smart contracts 706 correspond directly to smart contracts 504. Smart contracts 706 may receive on-demand request 702 in interactive distributive platform 708. Smart contracts 706, together with on-demand request 702, may enter interactive distributive platform 708. Interactive distributive platform 708 may validate on-demand request 702. Interactive distributive platform 708 may direct smart contracts 706 to the correct node to provide a correct response to on-demand request 702. The correct node may be found among nodes 710, 712, 714 and/or node 716. It should be noted that nodes may not be limited to nodes used and described herein. Smart contracts 706 may receive the correct response from one of the nodes selected by interactive distributive platform 708. Smart contracts 706 may transmit the correct response to on-demand request 702.

Thus, systems and methods for tokenizing and categorizing data transactions are provided. Persons skilled in the art will appreciate that the present invention can be practiced by other than the described embodiments, which are presented for purposes of illustration rather than of limitation. The present invention is limited only by the claims that follow.

What is claimed is:

1. A method for providing an interactive distributive platform, said interactive distributive platform that enables a single source of truth and consistent data recording, the method comprising:
creating a core preprogrammed generative AI algorithm, said generative AI algorithm collecting and parsing data, said collecting from a system with many sources of truth;
generating a corresponding dynamic grid, said generating using the AI algorithm, said dynamic grid using token rules and entity rules for combining and dividing the data;
extracting data from the dynamic grid, said extracting using the AI algorithm;
combining a plurality of datasets, said plurality of datasets emerging from the extraction;
clustering each of the datasets into one or more decentralized nodes, said clustering using smart contracts, said decentralized nodes from among a pool of decentralized nodes;
deriving information from each of the datasets, said deriving using smart contracts;
identifying a corresponding decentralized node for placement of the datasets, said identifying using the smart contracts;
selecting nodes for placement of the datasets, said selecting from among the pool of decentralized nodes, said selecting using smart contracts; and
assigning the datasets to one or more of the selected nodes found among the decentralized nodes, said assigning using the smart contracts.

2. The method of claim 1 wherein the selected nodes are further configured to validate the datasets in an interactive distributive platform, said validating creating a single source of truth.

3. The method of claim 1 wherein the system is configured to provide an interactive distributive platform in real-time.

4. The method of claim 1 wherein the token rules and the entity rules are configured to determine a unique value for the data, said determining based on a most common previously stored value for each of the data.

5. The method of claim 1 wherein the smart contracts are further configured to generate alert mechanisms for selected nodes, said selected nodes being selected for identification, and use with, external systems.

6. The method of claim 2 wherein the interactive distributive platform is further configured to validate the token rules and the entity rules.

7. The method of claim 5 wherein the interactive distributive platform is configured to accept requests and parse out data for use within the external systems.

8. An interactive distributive platform apparatus, said interactive distributive platform apparatus that enables a single source of truth and consistent data recording, the apparatus comprising;
a receiver, said receiver configured to receive entity identifier data;
a database, said database configured to record and store entity identifier data;
a microprocessor; said microprocessor configured to create a preprogrammed generative AI algorithm;
a dynamic grid, wherein the microprocessor uses token rules and entity data rules to combine, to generate, and to extract entity identifier data;
datasets, said datasets emerging from an extraction from the dynamic grid;
decentralized nodes, said decentralized nodes for assignment, placement and storage of the datasets;
a holochain, said holochain unifying the decentralized nodes;
smart contracts, said smart contracts arranged to cluster out the datasets to corresponding decentralized nodes; and
an interactive distributive platform, said interactive distributive platform configured for storage and placement of the datasets and corresponding nodes said interactive platform configured for validation of the datasets and corresponding nodes.

9. The apparatus of claim 8, wherein the microprocessor is configured to create the AI algorithm in real-time.

10. The apparatus of claim 8, wherein, the smart contracts are further configured to identify selected nodes from among the decentralized nodes.

11. The apparatus of claim 8, wherein the microprocessor is further configured to use the token rules and entity rules for determining a unique value for data said determining using values that have been previously stored.

12. The apparatus of claim 8, wherein each of the decentralized nodes is found among a pool of decentralized nodes said pool of decentralized nodes connoting a holochain.

13. The apparatus of claim 8, wherein, the microprocessor is further configured in:
processing the smart contracts; and
assigning, said assigning using the smart contracts, the datasets to selected nodes.

14. The apparatus of claim 8, wherein the smart contracts are further configured to generate alert mechanisms for selected nodes, said selected nodes being selected use with external systems.

15. A method for providing responses to one or more on-demand requests, said on-demand requests that enter a system, said providing creating an interactive distributive platform, said interactive distributive platform enabling a single source of truth, consistent data recording and easing responses to on-demand requests, the method comprising:
creating a core preprogrammed generative AI algorithm, said generative AI algorithm that collects and parses data, said data collecting from many sources of truth, said many sources of truth collecting data input into the system;
generating a corresponding dynamic grid, said generating using the AI algorithm;
combining and dividing the data, said combining and dividing the data using token rules and entity rules in the dynamic grid;
extracting the data, said extracting the data from the dynamic grid using the AI algorithm;
combining a plurality of datasets, said plurality of datasets emerging from the extraction;
clustering each of the datasets into one or more decentralized nodes, said clustering using smart contracts, said decentralized nodes found among a pool of nodes, said smart contracts deriving information from each of the datasets to identify a corresponding decentralized node for placement of the datasets;
selecting nodes for placement of the datasets, said selecting from among the pool of decentralized nodes;
assigning the datasets to one or more of the selected nodes found among the decentralized nodes, said assigning using the smart contracts;
validating the datasets, the entity rules and the token rules in an interactive distributive platform, said validating creating a single source of truth; and
determining datasets that require identification, and use with, external systems, said determining using the interactive distributive platform and smart contracts providing a response to the one or more on-demand requests.

16. The method of claim 15 wherein providing the response to the one or more on-demand requests occurs in real-time.

17. The method of claim 15, wherein the smart contracts are further configured to generate alert mechanisms for selected nodes, said selected nodes being selected because the selected nodes are configured for use with external systems.

18. The method of claim 15, wherein the token rules and the entity rules are configured to divide the data by creating a unique value for all the data, said creating a unique value by determining one value from among previously stored values.
